(19) United States
(12) Patent Application Publication
(10) Pub. No.: US 2003/0010818 A1
(43) Pub. Date: Jan. 16, 2003

(54) Print for pay printer

(76) Inventor: Stuart Asawaka, San Diego, CA (US)

Correspondence Address: HEWLETT-PACKARD COMPANY, Intellectual Property Administration, P.O. Box 272400, Fort Collins, CO, 80527-2400, US

(21) Appl. No.: 09/905,623

(22) Filed: Jul. 13, 2001

(51) Int. Cl. G06F 17/60

(52) U.S. Cl. 235/379

(57) ABSTRACT

A printer makes available certain printer resources and tracks use of such resources. Based on the printer users right to access or on actual use of certain printer resources, the printer triggers a payment transaction between the printer user and a resource vendor. The printer user pays for infrequently used printer resources as a function of use or as a function of a limited right of access to use. This more efficiently makes printer resources available to the printer user. The printer user need not pay for certain printer resources on a full time basis, rather only when such printer resources are needed.

### BACKGROUND OF THE INVENTION

The present invention relates generally to automated resource use and billing, and more particularly to automated printer resource use and payment.

Printers provide a variety of resources across selected printer models. Users of printers may or may not wish to take advantage of a full spectrum of available resources. Printer users must decide at the time purchase what level of resources are needed and purchase a printer model capable of providing such resources. Unfortunately, users do not make frequent use of certain resources. Users must nevertheless purchase printer models capable of a given range of resources corresponding to all potential uses contemplated for a particular printer. As a result, users must purchase printers having certain resources even though infrequently required. Thus, the printer user has certain basic needs but at times has special needs for certain jobs. The user must purchase a printer having resource capabilities to cover all potential uses, i.e., even infrequent uses according to special resource needs.

Printer models are made available by printer manufacturers according to selected resource capabilities. More expensive printer models provide a broader range of resources while other less expensive printer models provide a smaller range of resources capabilities. Printer manufacturers must identify and group certain resource capabilities to match printer user needs. Unfortunately, a printer manufacturer cannot match exactly the resource needs of every printer user. Printer manufacturers must, therefore, provide a variety of printer models according to a variety of printer resource configurations to best meet user needs. Despite such efforts, however, printer manufacturers cannot meet exactly the resource needs of every printer user.

For example, printer models vary in page throughput, resolution, and sensor features. A particular user may, for standard everyday use, require only a relatively slow and relatively low-resolution printer. At times, however, this user needs high-resolution printing. The user must purchase a relatively more expensive printer model, i.e., a high-resolution printer, just for the sake the infrequently needed high-resolution printer output. Most of the time the high-resolution resource is not needed.

Printer users must purchase a printer model having all resource capabilities for all potential uses. Printer users thereby make inefficient use of funds expended on printer resources. In other words, printer users purchase printer models having resource capabilities which are infrequently used and normally idle.

Because it is difficult if not impossible to match precisely all printer users' resource needs, printer manufacturers must select a limited set of printer models for sale. Each printer model in the set of printer models provides a different resource set. The printer manufacturer attempts to make available printer resource capabilities matching as closely as possible expected classes of printer user needs. Because all printer users differ to some degree in their resource needs, however, printer manufacturers can never meet exactly every printer user's resource needs.

It would be desirable, therefore, to allow printer users to more efficiently make use of printer resources without forcing the printer user to select among a limited number of printer models each having pre-configured resource capabilities. The subject matter of the present invention addresses such printer resource inefficiencies.

### SUMMARY OF THE INVENTION

A printer operating under the present invention includes a plurality of printer resources. Some of the printer resources are considered core or freely available resources. Other ones of the plurality of printer resources, however, are associated with a fee for use or right of access to use. Requesting printer resources associated with an additional fee triggers a payment transaction between the printer user and a resource vendor. In this manner printer users make more efficient use of infrequently used but necessary printer resources.

The subject matter of the present invention is particularly pointed out and distinctly claimed in the concluding portion of this specification. However, both the organization and method of operation of the invention, together with further advantages and objects thereof, may best be understood by reference to the following description taken with the accompanying drawings wherein like reference characters refer to like elements.

### BRIEF DESCRIPTION OF THE DRAWINGS

For a better understanding of the invention, and to show how the same may be carried into effect, reference will now be made, by way of example, to the accompanying drawings in which:

FIG. 1 illustrates generally a print for pay system according to the present invention.

FIG. 2 illustrates a particular print for pay system according to the present invention including automated communication between a printer and a resource vendor.

FIG. 3 illustrates a particular print for pay system according to the present invention including multiple users and automated resource reporting and payment transactions.

FIG. 4 illustrates a particular print for pay system according to the present invention including reporting of use to an internal accounting system and payment transactions with a resource vendor.

FIG. 5 illustrates a particular print for pay system according to the present invention including production of invoice and use reporting by hardcopy and payment to a resource vendor.

FIG. 6 illustrates organization of printer resources according to layer.

FIG. 7 illustrates organization of printer resources according to individual resources.

FIG. 8 illustrates a programmable consumable or supply element in a printer according another embodiment of the present invention.

FIG. 9 illustrates processing steps executed by the programmable element as shown in FIG. 8.

### DETAILED DESCRIPTION OF THE PREFERRED EMBODIMENT

The present invention recognizes that printer users do not make frequent use of certain printer resources but do have need for certain such printer resources. In accordance with the present invention, a printer makes available certain printer resources to the printer user and tracks use of such printer resources. Based on the printer user's right to access or on actual use of certain printer resources, the present invention triggers a payment transaction between the printer user and a resource vendor. The printer user pays for infrequently used printer resources as a function of use. This more efficiently makes printer resources available to the printer user. In other words, the printer user need not pay for certain printer resources on a full time basis, rather only when such printer resources are needed.

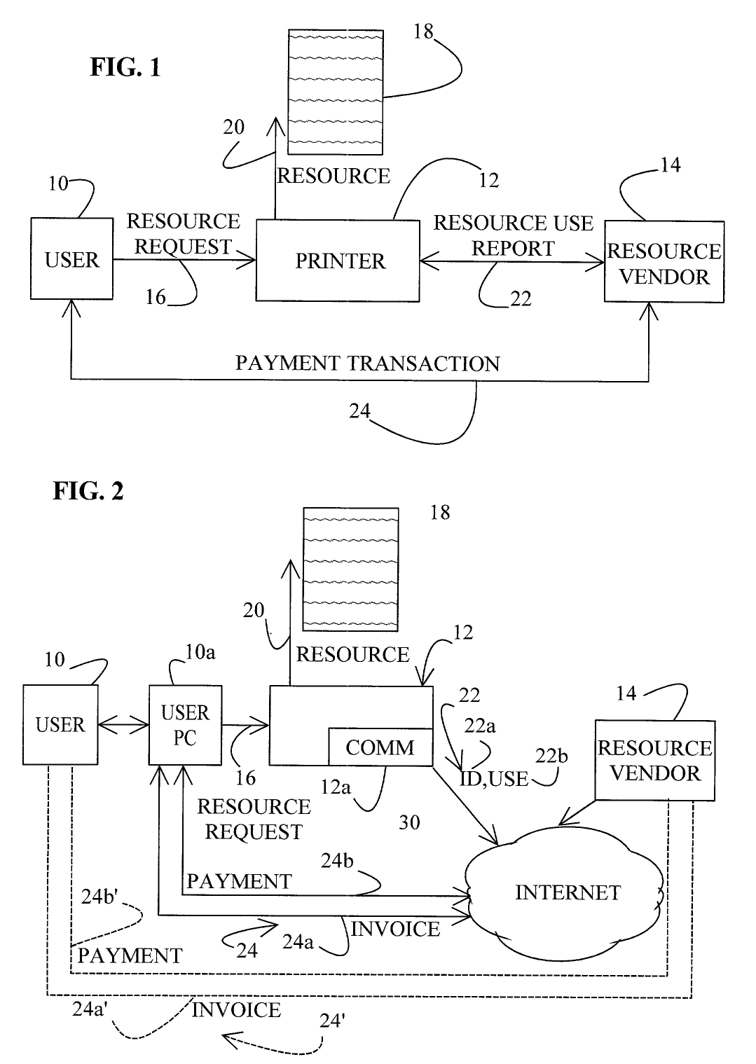

FIG. 1 illustrates generally the present invention including a user 10, a print for pay printer 12, and a resource vendor 14. In accordance with the present invention, user 10 submits to printer 12 a resource request 16. Printer 12 responds by producing output 18 including a resource 20 as specified in resource request 16. Printer 12 produces a resource use report 22 for delivery to resource vendor 14. Resource vendor 14 then initiates a payment transaction 24. Under transaction 24, vendor 14 collects funds from user 10 as a function of access to or use of resource 20.

The particular methods of communication available between user 10, printer 12, and resource vendor 14 may vary according to a broad spectrum of communication channels. Also, if user 10 utilizes core level resources, i.e., resources for which there is no additional charge, the transaction is simplified and no use report 22 need be generated and resource vendor 14 need not be contacted. Generally, use report 22 and interaction with resource vendor 14 is a result of user 10 utilizing resources for which there is a fee, i.e., resources beyond a core set of resources.

FIG. 2 illustrates one particular configuration available under the present invention where printer 12 includes a communication module 12a capable of communication by way of a global communications network 30, e.g., the Internet. User 10 interacts with printer 12 by way of a user personal computer (PC) 10a. PC 10a couples to printer 12 by a variety of communication channels, e.g., conventional direct cable connection, network connection, infrared connection, wireless radio signal connection, and the like. User 10 operates PC 10a to invoke a resource request 16 as described above and printer 12 produces output 18 including resource 20 as requested by user 10. Printer 12 reports such use by way of communication module 12a. In other words, printer 12 invokes by way of communication module 12a a communication by way of network 30 including a printer ID 22a and a use report 22b. Resource vendor 14 upon receiving use report 22, including ID 22a and use report 22b, generates an invoice 24a directed to user 10 at PC 10a. In response, user 10 generates a payment 24b, e.g., an electronic payment, at user PC 10a and in favor of resource vendor 14. Such payment may be provided by way of network 30 resulting in a direct credit to resource vendor 14 according to known money transaction methods as available across network 30. In the alternative, transaction 24 may be conducted according to a variety of conventional methods including a paper invoice 24a′ mailed to user 10 and a paper payment 24b′ mailed in response to invoice 24a′ to vendor 14.

As may be appreciated, user 10 as described herein may be one or a plurality of individual people making use of printer 12. In such case, ID 22a may include identification of individual users within an organization, departments within an organization, or an organization as a whole.

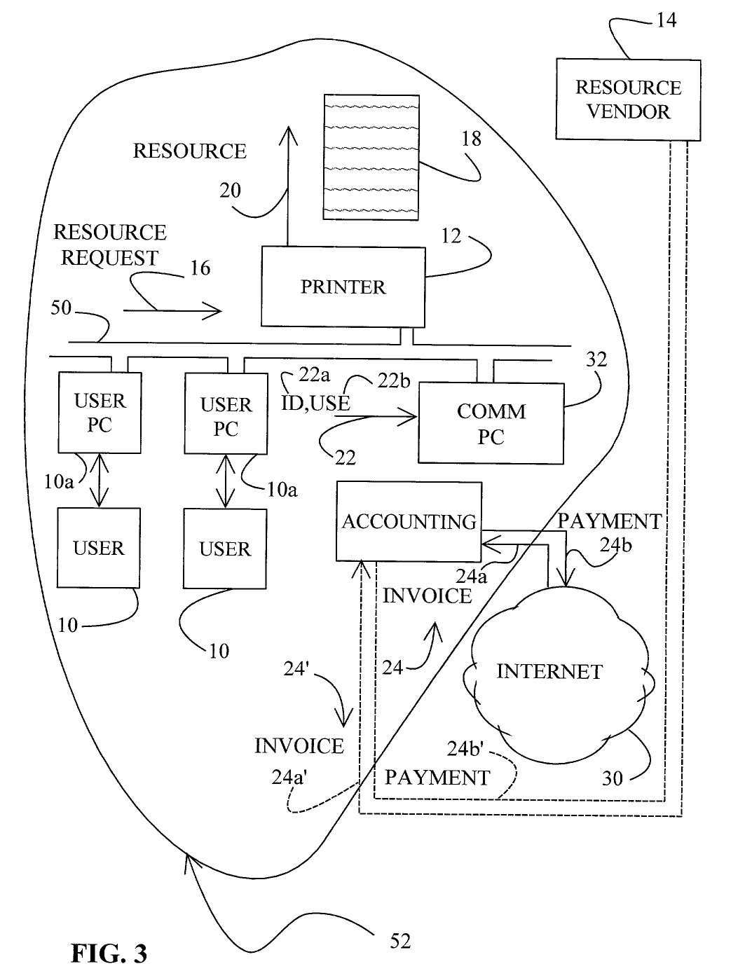

FIG. 3 illustrates an alternative configuration and method of communication according to the present invention. In FIG. 3, a local area network (LAN) 50 includes a plurality of users 10 each having an associated user PC 10a. All of users 10 have access to printer 12 by way of LAN 50. Accordingly, users 10 regularly make use of printer 12 including various resource requests 16. In response, printer 12 produces output 18 including a requested resource 20 as a function of a resource request 16. Collectively, users 10, PCs 10a, LAN 50, printer 12, communication PC 32, and accounting department 34 constitute an organization 52.

In this aspect, LAN 50 operates in conventional fashion allowing a plurality users access to a common printer. Printer 12 under the present invention, however, interacts by way of LAN 50 with a communication PC 32. Printer 12 delivers a resource use report 22 to communication PC 32. As described above, report 22 includes an ID 22a and a use data portion 22b. Communication PC 32 collects reports 22 according to the use made of printer 12 by users 10. Communication PC 32 collects use reports 22 and, either individually or in batch fashion, transmits use reports 22 by way of network 30 to resource vendor 14. In response, resource vendor 14 initiates a payment transaction 24, i.e., issues an invoice 24a and receives from accounting department 34a payment 24b. In the particular example illustrated in FIG. 3, payment transaction 24 occurs by way of network 30 but may be conducted across a variety mechanisms including conventional paper invoicing and paper payment.

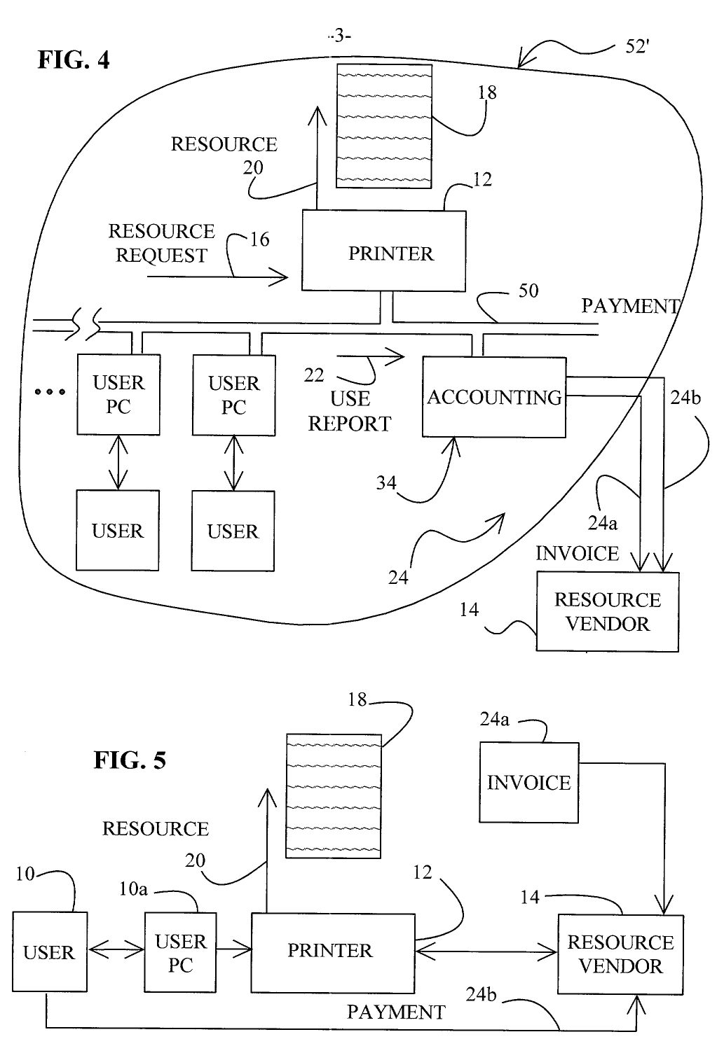

FIG. 4 illustrates an alternative configuration according to the present invention including as described above a plurality of users 10 and PCs 10a operating on a LAN 50. LAN 50 also couples to printer 12 and printer 12 provides output 18 including resource 20 as requested by users 10 according to resource requests 16. In this configuration, however, printer 12 delivers directly to accounting department 34 by way of LAN 50 a use report 22. Accounting department 34 analyzes use reports 22 and calculates a dollar amount due as a result of reported use of printer 12, i.e., as represented by use reports 22. Accounting department 34 then produces a consolidated use report 22′ and payment 24b for delivery to vendor 14. As may be appreciated, the mechanism employed to support transaction 22 may be by a variety of known methods, e.g., by fully automated electronic interaction or by conventional paper-based methods.

FIG. 5 illustrates an alternative configuration for the present invention including a user 10 and user PC 10a coupled to printer 12 with printer 12 providing output 18 including resource 20 as requested by a user 10. Under this configuration, however, printer 12 produces in hard copy an invoice 24a reflecting accumulated or individual resource requests16. In response, user 10 provides a payment 24b along with a copy of invoice 24a to resource vendor 14. Under this configuration, it would be desirable to include an additional mechanism allowing resource vendor 14 to confirm actual usage of printer 12. For example, printer 12 could be configured to regularly produce an invoice 24a whether or not funds were due. User 10 is then expected to provide such regularly produced invoices 24a to resource vendor 14. In this manner, resource vendor 14 regularly receives use indication from user 10 and is thereby regularly informed of all resource use of printer 12.

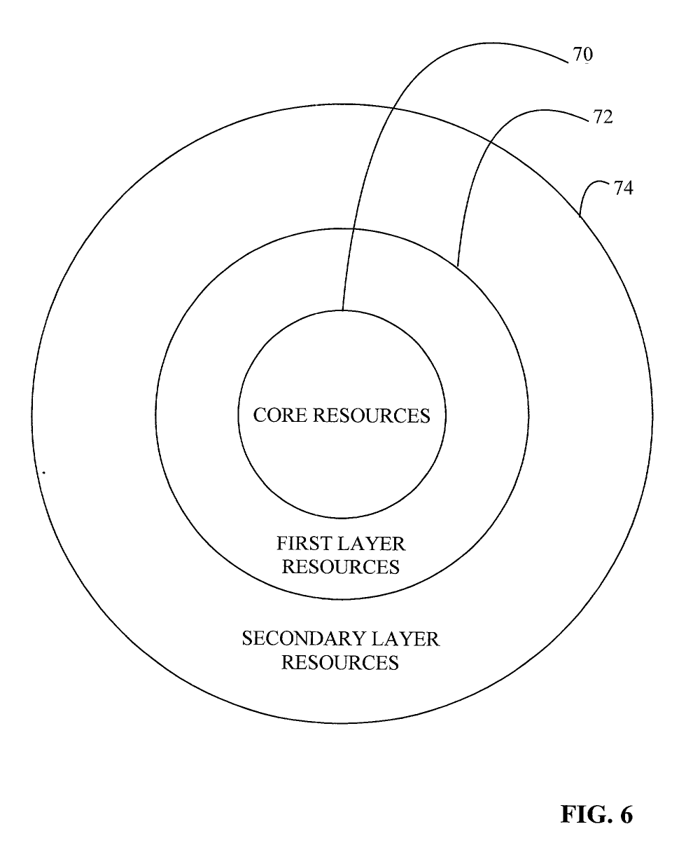

FIG. 6 illustrates printer resources divided into layers, in this example three layers, to stratify price levels. Any number of layers, however, may be used. A core layer 70 contains the basic printer resources needed to print standard output, e.g., frequently used resources, for which there is no fee. Core layer 70 resources include: nominal throughput, e.g., 12 pages/min; nominal quality level, e.g., as for typical text and images; nominal ink level sensor, e.g., “out of ink” detector; and nominal resolution, e.g., 600 dpi.

A first layer 72 contains additional or enhanced resources relative to the core layer 70 resources. First layer 70 resources include (in addition to the core 70 resources): faster throughput, e.g., 24 pages per/min; premium quality level, e.g., suitable for photos and the like; enhanced ink level sensor, e.g., prints a page, displays an “on screen” message, sends an email, or otherwise notifies the user of ink level including “ink low” indicator; and better resolution, e.g., 1200 dpi.

A second layer 74 contains additional or enhanced resources relative to the combined core layer 70 and first layer 72 resources. Second layer 74 resources include (in addition to first and second layer resources): even fastest throughput, e.g., 36 pages per/min; super premium quality, e.g., professional photo or offset printing capabilities; even better ink level sensor, e.g., automatically orders new supplies and prints or emails an invoice for the ordered supplies; and premium resolution, e.g., 2400 dpi.

Organization 52 can purchase a given level of resources either by the job or on a subscription basis. Subscriptions can be short term or long term, i.e., reference some time period of allowed specific resource use.

Consider organization 52 as a tax preparation service. Organization 52 purchases printer 12 at a relatively low price. When business gets very busy, i.e., at tax time, organization 52 selects a print for pay option giving greater page throughput. For example, printer 12 initially operates at 12 pages per minute. For an additional fee, organization 52 wants high-speed printing. This can be purchased by incident of use, e.g., by the job, or may be purchased for permanent full time use or for extended time of use. Thus, when needed organization 52 can print at high speed, e.g., 36 pages per minute. For each print job requesting high speed (or for a subscription time period allowing full access) organization 52 pays a premium, e.g., from 1 to 5 cents per page. Time period pricing could be a fixed increment for the day, week, or month such as a short-term resource subscription. For example, organization 52 shuts off the “high speed subscription” after the busy season. In other words, organization 52 switches off this premium service and returns to the nominal 12 page per minute speed.

As business grows, organization 52 decides to purchase a long-term or permanent resource subscription for a given fee, e.g., less than purchase of a new printer, to permanently enable a 36 page per minute speed. Organization 52 may find need for photo-quality resolution and purchase, on a per job or a subscription basis, enhanced resolution for output 18.

While a limited number of printer resources have been referenced herein by example of specific embodiments, it will be understood that a variety of additional printer resources and features may be incorporated into a print for pay system as described herein. For example, printers according to the present invention can be configured to interact on a LAN, i.e., a user requests activation of a LAN port on the printer. This constitutes a resource request for which a fee is collected under the present invention. Similarly, a printer can be used as an Internet node, i.e., the user requests connection as an appliance on the Internet. Other enhanced communication features can be considered a printer resource available by resource request under the present invention. For a given fee the user activates an infrared link port for coupling to a laptop computer. Because this is an infrequently used, but sometimes essential, printer resource the user wants access to an infra-red link but can't necessarily justify the cost of a relatively more expensive printer having a full-time infrared link port. Under the present invention, the user has access to this infrared link, but need not pay the price of a conventional printer having such link. Thus, a variety of printer resources may be incorporated into a print for pay system as described herein where users pay for resources on a use or subscription basis.

Resource pricing need not follow a layered approach. Each resource can be individually accessed for a corresponding fee. The user need not combine, i.e., pay for, other resources not needed at that time. In other words, users mix and match resources to form a selected printer resource configuration matching exactly their resource needs on an ongoing basis, e.g., subscription, or on a per use basis, e.g., by the job.

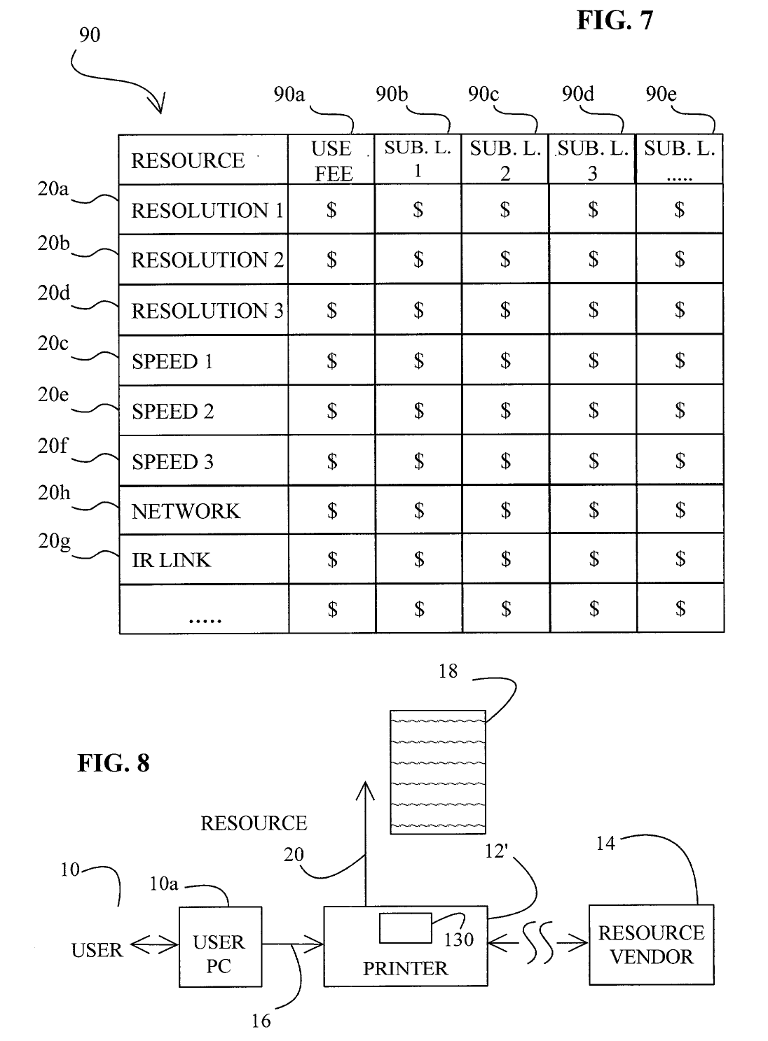

In FIG. 7, table 90 represents organization of printer 12 resources 20 according to individual resources. A user or organization purchases certain basic-level resources for full time use and then subscribes to or obtains per job selected enhanced or additional printer resources. Use report 22 reflects use of printer 12 sufficiently to produce an invoice according to whatever pricing arrangement is in place for that user or organization. Generally, table 90, illustrates that printer resources 20 may be individually designated and fall under separate subscription or use fee arrangements. Thus, it will be understood that the present invention contemplates a variety of fee arrangements wherein printer resources 20 may be broken into sets or layers (as in FIG. 6) or treated individually (as in FIG. 7) or a mixture of layered and individual pricing schedules.

In the specific example of FIG. 7, resources 20 are divided into individually designated resources 20a-20h. In some cases, resources are individually designated accordingly to a gradation or resource level. For example, resources 20a-20c illustrate different degrees of resolution available. Similarly, resources 20d-20f illustrate different printing speeds available. In the case of resource 20g, however, printer 12 may be set to operate as a network printer by invoking use of or right to access to resource 20g. Similarly, printer 12 may be set to include a right to access to its IR link 20h. Furthermore, it will be understood that the particular resources 20a-20h set forth in FIG. 7 are only presented herein as examples of a broad spectrum of resources which may fall under the present invention.

The columns set forth in table 90 correspond to various fee arrangements applicable to resources 20. For example, column 90a corresponds to a “per use” fee arrangement. Under the fee arrangement of column 90a, a resource 20 invoked will incur the corresponding fee found in column 90. Columns 90b-90d correspond to various subscription levels of varying duration. For example, subscription level 1 as set forth column 90b may correspond to one day whereas columns 90c and 90d correspond to longer time periods, e.g., monthly or quarterly respectively. Finally, fee column 90e corresponds to a “switch” fee arrangement where the user purchases permanently or, until “switched off”, the corresponding resource 20. In each case, table 90 includes a collection of cells holding a dollar value, indicated only symbolically in table 90. Users of printer 12 evaluate table 90 to determine the most suitable and most efficient use of printer 12 according to their particular needs.

Thus, a given user may select a specific resolution, printer speed, network capability, communication links and the like according to particular needs either on a permanent, temporary, or per-use basis.

As will be appreciated, the system of FIG. 5 may be expanded into more complicated system, e.g., such as illustrated in FIGS. 2-4, but making use of printer 12 to produce a hard copy use report 22.

While illustrated herein as employing a single print for pay printer 12, the present invention contemplates also use of a plurality of printers 12 as used within a given organization and producing a consolidated use report 22 collecting all resource 20 use throughout a given population of pay for printers 12.

While the present invention has been described herein with reference to printer tracking and reporting of resource use, it will be understood that a variety hardware and programming methods may be used to implement the present invention. Generally, resource use detection and processing of use information to produce resource reports 22 may be distributed between a host computer from which a print operation originates and the print for pay printer as provided under the present invention. A print for pay printer itself may include certain processing and memory elements capable of detecting resource use and aiding in or generating entirely use reports 22.

Thus, a programmable memory chip can be placed on the ink cartridge, the print head or possibly in the printer itself. Currently, some printers make use of similar technology, i.e., placement of programmable memory chips on the ink cartridge, print head, or printer itself, to enhance printing and to track ink usage on the printer. Generally, such programmable memory elements can hold information that is set or reset according to designation by the resource vendor 14 in order to track resource 20 use in comparison to information held in the programmable chip. For example, such programmable memory chips can track charges, consolidate billing, and the like to implement the present invention. Certain portions of the memory can be designated for indicating activation or deactivation of particular resources 20. Thus, if a subscription or one time payment for full access is invoked, such programmable memory element can be modified to designate such resources as “non-fee” resources or part of the core resources for which there is no additional fee associated therewith through the subscription period in the case of a subscription account or thereafter in the case of a permanent purchase of such resources.

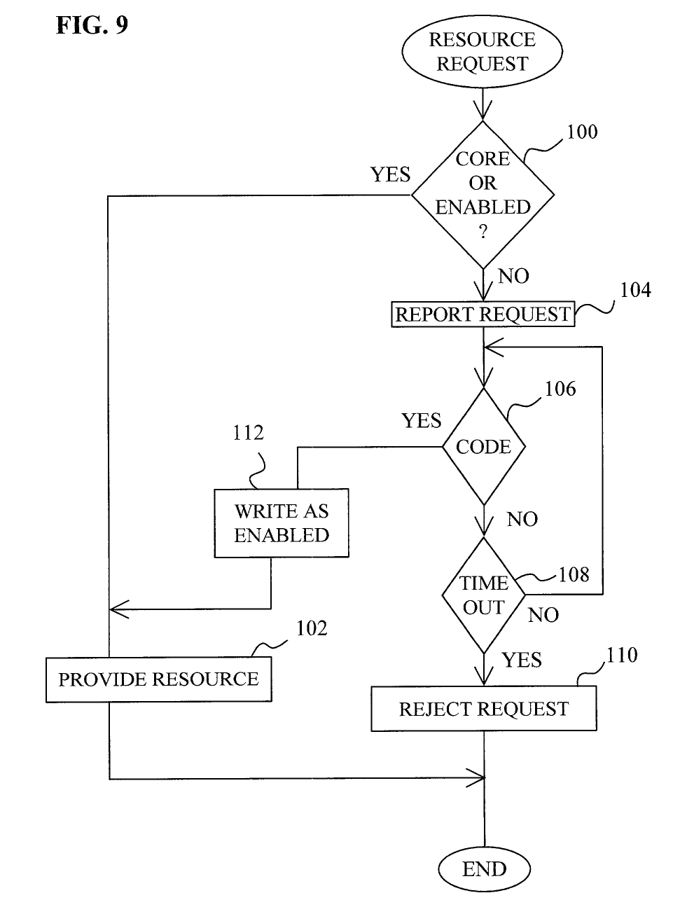

FIG. 8 illustrates a print for pay printer 12′ including a consumable or supply element 130, e.g., an ink supply cartridge, print head, or the like. Element 130 includes a programmable processing device including memory components. As described above, printer 12′ receives a resource request 16 via a user PC 10a and originating from a user 10. Printer 12′ produces output 18 which includes when requested a given resource 20. As discussed above, a given resource 20 may include speed of output, quality of output, channels of communication, and other such printer resources as described herein. Printer 12′ also includes communication capabilities for interacting with resource vendor 14 as described above. Element 130 tracks resource request 16 and determines operation of printer 12′ as set forth in FIG. 9.

In FIG. 9, a resource request 16 triggers an initial inquiry by element 130 as indicated in decision block 100. If the resource request constitutes a core or previously enabled resource 20 then processing advances to block 102 where printer 12′ provides the resource 16 as requested, i.e., provides the requested resource in quality or speed of output 18 or by augmentation of communication channels, e.g., network or infra-red capability. If the resource request 16 is not for a core or previously enabled resource 20, then processing advances to block 104 where element 130 reports the resource request 16 to resource vendor 14 by means of the previously described and various communication channels available for interaction with resource vendor 14. Processing then loops at decision blocks 106 and 108 until resource vendor 14 returns an authorization code for access to the requested resource 20 or a time out condition occurs. Thus, in decision block 106 if the authorization code has not yet returned from resource vendor 14, then processing branches down through the time out decision block 108. If a time condition has not yet occurred, then processing returns to decision block 106. If a time out condition has occurred, however, then processing advances to block 110 where printer 12′ rejects the resource request for lack of the return authorization code. If, however, in decision block 106 resource vendor 14 has returned the authorization code then processing advances through block 112 where element 130 marks in its memory component the particular resource 20, i.e., that embodied in resource request 16, as now being enabled. Processing then advances to block 102 where printer 12′ provides the resource as requested. Included in the processing of block 102, any necessary billing or invoicing and payment transactions are triggered as described above. Following block 110, processing terminates.

It will be appreciated that the present invention is not restricted to the particular embodiment that has been described and illustrated, and that variations may be made therein without departing from the scope of the invention as found in the appended claims and equivalents thereof.

What is claimed is:

1. A method of operating a printer, said method comprising:
providing a printer including a plurality of printer resources;
receiving a resource request at said printer, said resource request including a request for at least one of use and a right of use of a selected at least one printer resource;
operating said printer according to said resource request including at least one of use of and right of use of said selected at least one printer resource; and
initiating a payment transaction based on said operating step.

2. A method according to claim 1 wherein said printer initiates said payment transaction.

3. A method according to claim 2 wherein said printer includes a consumable element, said consumable element including a processing element initiating said payment transaction.

4. A method according to claim 1 wherein said selected printer resource comprises enhanced output produced by said printer relative to output produced without use of said selected at least one printer resource.

5. A method according to claim 4 wherein said selected at least one printer resource comprises a selected printer resolution.

6. A method according to claim 4 wherein said selected at least one printer resource comprises a selected printer throughput speed.

7. A method according to claim 1 wherein said selected at least one printer resource comprises access to a selected communication channel.

8. A method according to claim 7 wherein said selected communication channel comprises at least one of an IR link and a network link.

9. A printing system comprising:
printer control including a plurality of resources supporting operation of a printer, said plurality of printer resources comprising a first resource set and a second resource set;
print job control receiving a request relative to at least one of said plurality of printer resources; and
transaction control detecting said request and initiating a payment transaction for said request when said at least one of said plurality of printer resources is a member of said second set.

10. A system according to claim 9 wherein said request comprises an incident of use for said at least one of said plurality of printer resources.

11. A system according to claim 9 wherein said request comprises a period of allowed right of access to said at least one of said plurality of printer resources.

12. A system according to claim 9 wherein said request comprises a request to remove said at least one of said plurality of printer resources from said second set and place said at least one of said plurality of printer resources in said first set.

13. A system according to claim 9 wherein said transaction control is located within said printer.

14. A system according to claim 9 wherein said transaction control generates a use report for delivery to a resource vendor.

15. A system according to claim 9 wherein said at least one of said plurality of printer resources comprises enhanced output produced by said printer relative to output produced without use of said at least one of said plurality of printer resources.

16. A system according to claim 15 wherein said at least one of said plurality of printer resources comprises a selected printer resolution.

17. A system according to claim 15 wherein said at least one of said plurality of printer resources comprises a selected printer throughput speed.

18. A system according to claim 15 wherein said at least one of said plurality of printer resources comprises access to selected communication channel.

19. A method of printer operation comprising the steps:
requesting a print job, said print job including use of a selected printer resource;
printing at a printer said print job including use of said selected printer resource; and
executing a payment transaction in favor of a resource vendor as a function of said print job.

20. A method according to claim 19 wherein said method further comprises reporting use of said selected printer resource to said resource vendor.
